(19) United States
(12) Patent Application Publication
(10) Pub. No.: US 2026/0108413 A1
(43) Pub. Date: Apr. 23, 2026

(54) Abdominal Pressure Exsufflation Belt

(71) Applicant: Lung Assist II Inc., Boulder, CO (US)

(72) Inventors: Dano S. Carbone, Florrisant, CO (US); Lewis W. Ward, Boulder, CO (US)

(21) Appl. No.: 18/999,659

(22) Filed: Dec. 23, 2024

Related U.S. Application Data
(60) Provisional application No. 63/629,971, filed on Dec. 26, 2023.

(51) Int. Cl. A61H 1/00

(52) U.S. Cl. CPC A61H 1/008; A61H 2201/0103; A61H 2201/0157; A61H 2201/1238; A61H 2201/14; A61H 2201/163; A61H 2201/165; A61H 2201/5056; A61H 2201/5071; A61H 2205/083; A61H 2230/201; A61H 2230/405

(57) ABSTRACT

An abdominal pressure exsufflation belt is disclosed. An example of the abdominal pressure exsufflation belt includes an abdominal belt configured to be worn by a person about their abdomen. The exsufflation belt also includes a pouch of the abdominal belt. The exsufflation belt also includes a bladder in the pouch. The exsufflation belt also includes tubing connected between the bladder and an external ventilator to enable air flow from the external ventilator to expand the bladder and press against the abdomen of the person wearing the abdominal belt. Expansion of the bladder delivers a force to the abdomen resulting in expiration as the external ventilator inflates the bladder, followed in sequence by passive inspiration by the person wearing the abdominal belt as the bladder deflates.

### CROSS REFERENCE TO RELATED APPLICATIONS

This application claims the priority benefit of U.S. Provisional Patent Application No. 63/629,971 filed Dec. 26, 2023 for “Abdominal Pressure Exsufflation Belt” of Lewis W. Ward, hereby incorporated by reference in its entirety as though fully set forth herein.

### BACKGROUND

Diseases that may cause debilitating breathing symptoms include post-polio, amyotrophic lateral sclerosis (ALS), muscular dystrophy, diaphragmatic dysfunction, paralytic/restrictive pulmonary syndromes, spinal muscular atrophy, scoliosis/kyphoscoliosis, high spinal cord injury, and chronic alveolar hypoventilation, among others. People with these, and other breathing disorders, can be assisted to breathe by mechanical ventilation. However, there has been no real innovation in mechanical ventilation in the past 50 years. Professionals have long recognized that positive pressure ventilators have serious limitations to provide inspiratory and expiratory ventilation.

Patients, caregivers, and respiratory professionals are concerned that traditional mechanical ventilation confines the patient to 24-hour use of a mask or breathing tube. With these masks or breathing tubes, many patients experience negative effects, such as the inability to sit up, inhibited mobility, respiratory muscle weakness and diaphragmatic paralysis, trouble swallowing and coughing, obstructive breathing and confinement of upper extremities and mouth.

Inspiratory and expiratory phases of breathing are limited by mechanical ventilation. Facial masks may cause mid-facial hyperplasia and facial necrosis with long-term use. Swallowing and coughing is also impeded by using a mask or breathing tube.

### BRIEF DESCRIPTION OF THE DRAWINGS

FIG. 1 is a front view of an example abdominal pressure exsufflation belt as it may be worn about the abdomen of a person or patient.

FIG. 2 is a rear view of the example abdominal pressure exsufflation belt.

FIG. 3 shows an example bladder of the example abdominal pressure exsufflation belt.

FIG. 4 shows example air flow tubing of the example abdominal pressure exsufflation belt.

FIG. 5 shows example ventilator tubing of the example abdominal pressure exsufflation belt.

FIG. 6 shows an example adapter and manometer of the example abdominal pressure exsufflation belt.

FIGS. 7-8 illustrate example operation of the example abdominal pressure exsufflation belt.

### DETAILED DESCRIPTION

A breathing apparatus is disclosed that assists people with breathing. In an example, the breathing apparatus may be configured as an intermittent external abdominal positive pressure ventilator (IAPPV). More specifically, the apparatus is an abdominal pressure exsufflation belt that decreases the work of breathing and increases tidal volumes resulting in improved quality of life. The term “tidal volume” refers to the total amount of air inhaled or exhaled during breathing. The term “exsufflation” refers to the act of forcibly breathing out or blowing air, and is aided by use of the breathing apparatus disclosed herein.

An example breathing apparatus includes a belt (or “exsufflation belt”), a pouch to confine a bladder in the belt, and openings in the pouch at upper corners of the pouch to facilitate insertion of the bladder at either top side locations of the belt. The belt ends may be attached to one another behind the person, thereby securing the belt in place when worn by the person. A hook-and-loop (e.g., VELCRO™) and/or other suitable fastening system may be provided to maintain the belt about the abdomen of the person during use. The belt may be manufactured of cloth or denim, or any suitable material that provides comfort for the person wearing the belt, with sufficient rigidness for the bladder to operate as disclosed herein.

In an example, additional support may be provided in the belt, such as with clothing stays located in pockets or slots in the front wall of the belt (e.g., sewn into or otherwise provided in the belt) that direct the bladder pressure toward the abdomen of the person (or patient, as that term is used interchangeably herein) wearing the belt. Other support may be provided, e.g., by the material itself that forms or is otherwise located at the front wall of the belt. The belt wraps around the abdomen of the person to remain the bladder adjacent to the abdomen.

In an example, the bladder is connected to a ventilator. The ventilator may be operated to deliver airflow to the bladder, thereby providing a force against the abdomen of the person wearing the exsufflation belt. This causes at least a partially forced patient expiration, followed in sequence by passive inspiration (e.g., by the person without mechanical assistance) in response to the ventilator deflating the bladder.

In an example, the exsufflation belt fully inflates a patient's lungs and does not require the use of a facial mask or breathing tube, thereby reducing mid-facial hyperplasia and facial necrosis.

In an example, the exsufflation belt shape helps to provide anatomical support while the patient sits in an upright position.

The breathing apparatus functions the opposite of standard positive pressure mechanical ventilators. That is, the exsufflation belt works by providing abdominal compressions. Activation of the belt to fill the bladder causes exhalation, which is the opposite of a positive pressure mechanical ventilator which delivers airflow for inhalation.

The breathing apparatus is a simple and easy choice for any patient requiring non-invasive ventilation. The device is designed to be comfortable, easy to use, and adjustable to a variety of body sizes and shapes. It can be used in different settings both in or out of home and even in a work environment and it can be powered by most standard portable ventilators. The exsufflation belt provides an effective and safe delivery of passive inspiration for patients who may need ventilation, but without having to use a nasal or face mask.

In an example, the exsufflation belt provides the person with freedom of their mouth for eating and for speaking, even when the breathing apparatus is in use. The breathing apparatus can be used for daytime breathing assistance for patients that would otherwise remain on 24-hour full-time confining standard mechanical positive pressure ventilation, using a mask or mouth piece ventilation; or on negative pressure body wear ventilation.

The exsufflation belt is a noninvasive external intermittent abdominal positive pressure ventilator (IAPPV) product that can be used, for example, by respiratory people who experience the inability to sit up, inhibited mobility, respiratory muscle weakness, diaphragmatic paralysis, trouble swallowing, obstructive breathing, and confinement of upper extremities and/or the mouth. IAPV is a valid alternative to noninvasive mechanical ventilation that must use a nasal cannula or face mask. IAPV is a suitable alternative to mechanical ventilatory systems that require the use of masks or nasal cannulas.

The breathing apparatus has been shown to improve gas exchange and dyspnea symptoms. Mobility and quality of life is enhanced for the person using the breathing apparatus. Use of the breathing apparatus may decrease the incidence of pneumonia, and may avert the need for tracheal intubation or a tracheotomy. The breathing apparatus is also more cost-effective than traditional ventilation devices that apply positive pressure to the face via mask or cannula. The breathing apparatus is a cost effective, user friendly, at home device that administers unique reverse ventilation, active exhalation and passive inhalation.

Before continuing, it is noted that as used herein, the terms “includes” and “including” mean, but is not limited to, “includes” or “including” and “includes at least” or “including at least. ” The term “based on” means “based on” and “based at least in part on. ”

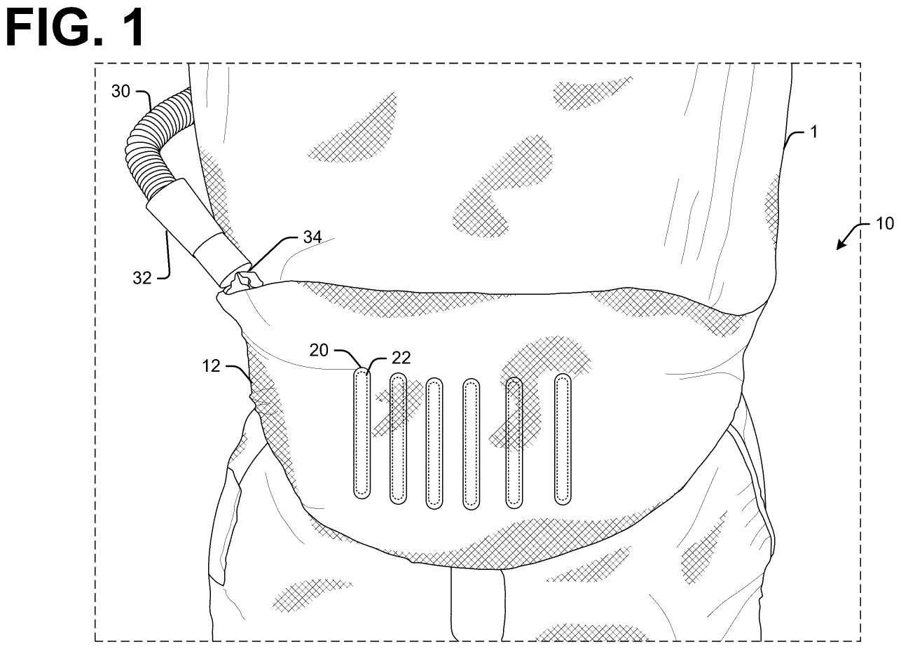

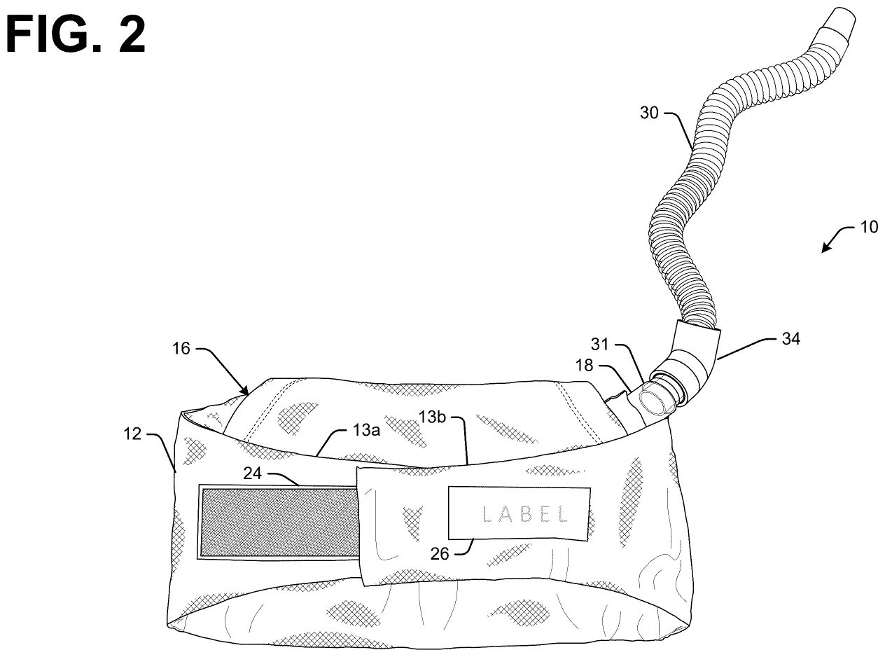

FIG. 1 is a front view of an example abdominal pressure exsufflation belt 10 as it may be worn about the abdomen 1 of a person or patient. FIG. 2 is a rear view of the example abdominal pressure exsufflation belt 10. The abdominal pressure exsufflation belt (or simply “exsufflation belt”) 10 may include an abdominal belt 12 configured with ends 13a and 13b to wrap entirely around (and attach behind the person) such that the abdominal belt 12 is worn about the abdomen 1.

An example abdominal pressure exsufflation belt 10 may also include one or more opening(s) 16 for providing a bladder 14 in a pouch 18, and for removing the bladder 14 from the pouch 18 (e.g., for cleaning or replacement). Tubing for connecting to the bladder 14 may also be provided through this same opening 16 and/or a separate opening.

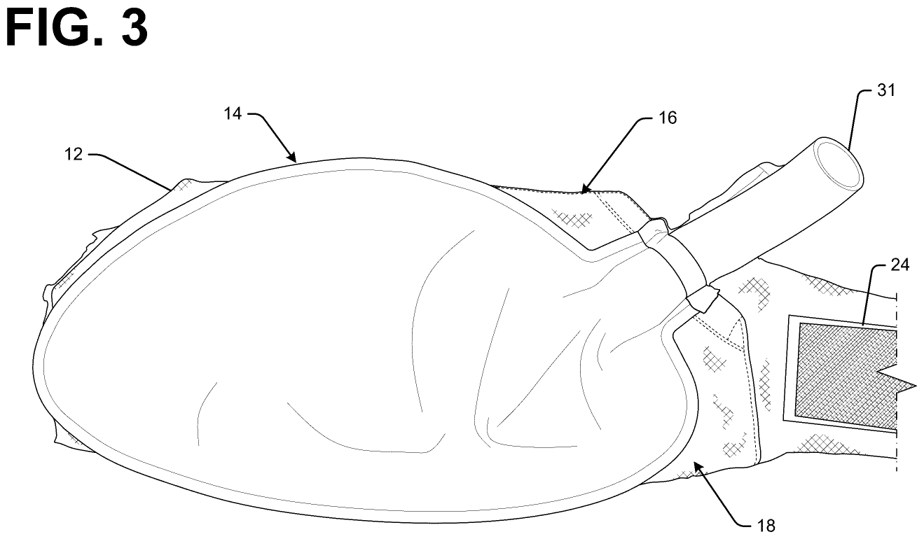

FIG. 3 shows an example bladder 14 of the example abdominal pressure exsufflation belt 10. In an example, the bladder 14 has a substantially oval shape. Other suitable shapes for the bladder 14 may also be provided. The pouch 18 is formed in the abdominal belt 12 (e.g., as a part of the belt 12), and the bladder 14 is provided in the pouch 18. When connected to a patient-supplied positive pressure ventilator, the bladder 14 is rhythmically inflated by a prescribed or preset rate and tidal volume to assist the patient.

The bladder can be made from polyester polyurethane (TPU) or other suitable material. The bladder may be formed in an oval shape with a polyurethane connector tube for filling and emptying the bladder. The bladder is installed into the knit pouch 18 on the abdominal belt 12, and during operation, exerts pressure against a patient's diaphragm to move the diaphragm upwards. This pressure causes patient forced exhalation.

In an example, the abdominal belt 12 is configured as a noninvasive, wearable, fabric corset. That is, the abdominal belt 12 may include one or more pocket or slot(s) 20 formed in the abdominal belt 12. One or more clothing stay 22 may be provided in slot(s) 20 of the abdominal belt 12. The clothing stay 22 may be plastic, metal or other suitable stiff material. The clothing stay 22 is configured and positioned in the slot(s) 20 of the abdominal belt 12 to provide a structure in an otherwise soft (fabric or denim) abdominal belt 12, such that pressure from the bladder 14 is directed toward the abdomen 1 of the person wearing the abdominal belt 12 (and not out and away from the person's body). Other examples for providing sufficient reinforcement (e.g., a rigid portion formed by a rigid structure in the abdominal belt 12) may also be provided, as will be understood by those having ordinary skill in the art after becoming familiar with the teachings herein.

An example abdominal pressure exsufflation belt 10 may also include a closure mechanism 24 to hold the abdominal belt 12 about the abdomen 1 of the person wearing the abdominal belt 12. The closure mechanism 24 can be a hook-and-loop closure. Other suitable closures may also be provided. An optional product label 26 is also shown on the abdominal belt 12 in FIG. 2.

In an example, the abdominal belt 12 is constructed of denim fabric material and/or knit cloth. This provides comfort to the person wearing the abdominal belt 12, making it more desirable to use. The denim material forms the shape of the abdominal belt 12. A knit material pocket or pouch 18 is attached (e.g., sewn) on the back of the denim form to hold the bladder 14. The pouch 18 can have slots sewn at each upper corner to install the bladder 14 into the abdominal belt 12. Hook-and-loop fasteners on the front and back of the denim form provides for ease-of-use adjustment and fastening the abdominal belt 12 around the abdomen 1.

In an example, the abdominal belt 12 is adjustable to fit various body sizes and shapes. This helps ensure a comfortable fit for all users and allows for easy adjustments as needed. In an example, an extender may be provided to enlarge the circumference of the abdominal belt 12 for larger individuals. The extender can be made of denim or other suitable material and sewn over a flexible polyester interfacing form. By way of illustration, the respiratory professional may use an extender with a medium sized belt to fit larger waist sizes up to about 48 inches.

The abdominal pressure exsufflation belt 10 is low maintenance or even maintenance-free, requiring little to no upkeep and ensuring reliability for long-term use. The abdominal belt 12 may be machine laundered using mild detergent and a gentle machine cycle. It is recommended to remove the bladder 14 and clothing stays 22 prior to washing. The abdominal belt 12 should be air dried or dried in a no heat machine cycle to avoid any shrinkage.

The bladder 14 is made of durable plastic material and should be removed before laundering the belt. The bladder 14 may be wiped clean with a damp cloth and mild detergent and then wiped with clean, clear water to remove any detergent residue. The inside of the bladder should be kept free of any liquids, moisture, or other foreign substances. The bladder 14 should not be exposed to prolonged direct sunlight or temperatures above 100 degrees Fahrenheit.

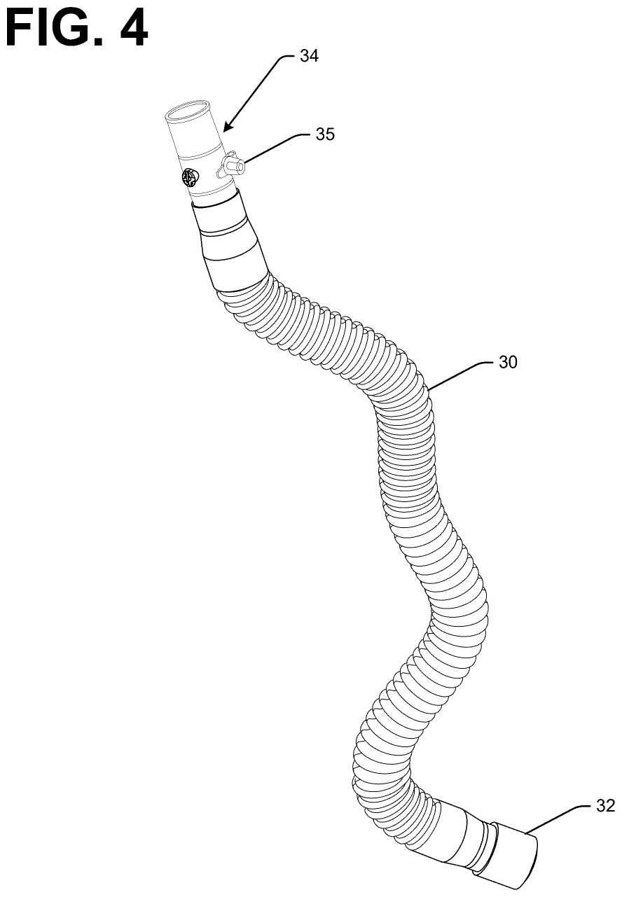

Air flow tubing 30 is connected on a first end via an adapter 34 to hose connector 31 of the bladder 14. FIG. 4 shows example air flow tubing 30 of the example abdominal pressure exsufflation belt 10. In an example, the air flow tubing 30 has a connector 32 that mates with a corresponding connector 37 of ventilator tubing 36.

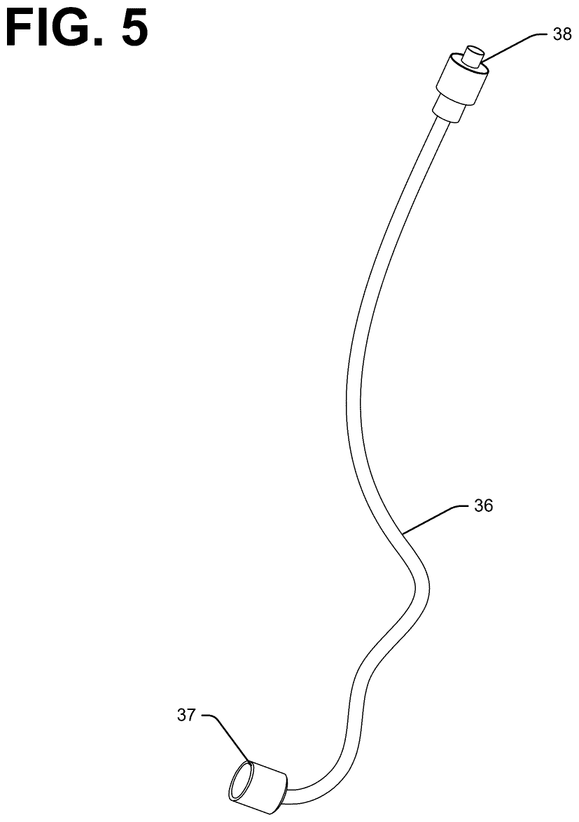

FIG. 5 shows example ventilator tubing 36 which may connect on a first end with connector 37 to adapter 34 and to the bladder 14; and on a second end with connector 38 to an external ventilator (e.g., a conventional mechanical ventilator, not shown). The ventilator delivers a force to the abdomen 1 resulting in expiration, followed in sequence by passive inspiration by the person wearing the abdominal belt 12 when the ventilator deflates the bladder 14.

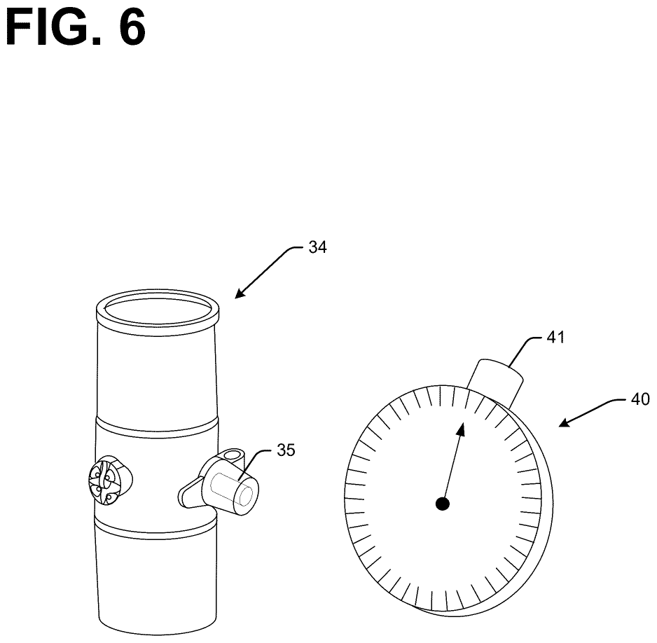

FIG. 6 shows an example adapter 34 and an example manometer 40 of the example abdominal pressure exsufflation belt 10. The manometer 40 may be provided inline with the tubing between the bladder 14 and the ventilator. For example, port 41 of the manometer 40 may be connected to port 35 of the adapter 34. The manometer 40 measures proximal pressure to the bladder 14. The manometer 40 may be connected with a connector that has an outside diameter of 22 mm. This size is most common for respiratory ventilation systems, and provides the ability to measure proximal pressure of the bladder 14.

The adapter 34 has no vents and therefore does not allow for backflow. The pressure can be measured without airflow exiting out into the atmosphere, which can create a loss of pressure in the bladder 14. The reference pressure read by the manometer 40 is valuable to the user as it is a benchmark for making sure the bladder 14 pressure values are consistent with the prescribed airflow. If pressure readings are off, the user should check to ensure a tight fit to the bladder hose, allowing the bladder 14 to maximize forced pressure from the set or prescribed ventilator settings.

Connectors and adapters may be universal fit adapters to enable ready use with various external ventilators. It is noted that while specific tubing, connectors and adapters are shown in the drawings and described above, it will be readily understood by those having ordinary skill in the art after becoming familiar with the teachings herein, that other tubing, connectors, and adapters may also be provided.

During assembly, the bladder 14 is inserted into the soft knit pouch 18 through one of the open slots in the upper corners. The hose connector 31 on the bladder 14 may be oriented to either of these two corners of the pouch 18 to accommodate patient comfort.

The abdominal belt 12 is tight-fitting to the patient, with a soft flannel surface positioned next to the patient over the abdomen 1. The lower bladder border rests slightly above the pubic arch, and the upper bladder border at the level of the xiphoid and lower sternum of the person wearing the abdominal belt 12. The lower portion of the rib cage of the person wearing the abdominal belt 12 is enclosed. Hook-and-loop straps 24 fasten on the abdominal belt 12 to secure the bladder 14 and pouch 18 in the proper position. The ventilation hose 36 connects the bladder 14 to the positive pressure ventilator.

The abdominal pressure exsufflation belt 10 is a non-invasive ventilator device designed to assist patients requiring mechanical ventilation without the need for a nasal or face mask. It utilizes Intermittent Abdominal Pressure Ventilation (IAPV) to provide passive inspiration through abdominal compressions. This makes it a comfortable and easy-to-use alternative for patients needing non-invasive ventilation. The abdominal belt 12 is adjustable to fit various body sizes and shapes, and can be used in different settings, including at home or in the workplace. It is compatible with most commercially available portable ventilators, and has been shown to improve gas exchange, reduce dyspnea symptoms, and enhance patients'mobility and quality of life. Additionally, it may decrease the incidence of pneumonia and avoid the need for tracheal intubation or tracheotomy.

The abdominal pressure exsufflation belt 10 assists patient respiration and may result in health improvements. The abdominal pressure exsufflation belt 10 offers benefits not available when using standard mechanical ventilation. For example, the patient is able to sit up for extended hours with an enhanced seating posture. The abdominal pressure exsufflation belt 10 decreases the work of breathing, while at the same time providing increased tidal volume that improves the patient's quality of life, dignity and confidence in a work place and in public settings. The lungs are fully inflated while resting the respiratory muscles during continued use. The abdominal pressure exsufflation belt 10 does not require a full-time facial mask or mouthpiece allowing the patient to speak and eat freely. The abdominal pressure exsufflation belt 10 reduces mid-facial hyperplasia and facial necrosis often experienced from long-term use of a mask. The patient also may experience improvement in swallowing and coughing.

By providing a non-invasive ventilation option, the abdominal pressure exsufflation belt 10 may reduce the risk of pneumonia, which is a common complication associated with invasive ventilation methods.

The abdominal pressure exsufflation belt 10 is primarily used during the day to assist with breathing. It helps in reducing the work of breathing and allows patients to rest their respiratory muscles. In other examples, however, the exsufflation belt may also be used at nighttime.

The abdominal pressure exsufflation belt 10 is simple to use and does not require extensive training. Patients can easily strap on the belt and connect it to their portable ventilator.

By providing a non-invasive ventilation option, the abdominal pressure exsufflation belt 10 improves patients'mobility and overall quality of life. It allows them to engage in daily activities without the discomfort and restrictions of traditional ventilators.

The abdominal pressure exsufflation belt 10 is discreet and reliable, making it an ideal choice for patients who need non-invasive ventilation without drawing attention.

Before continuing, it should be noted that the examples described above are provided for purposes of illustration, and are not intended to be limiting. Other devices and/or device configurations may be utilized to carry out the operations described herein.

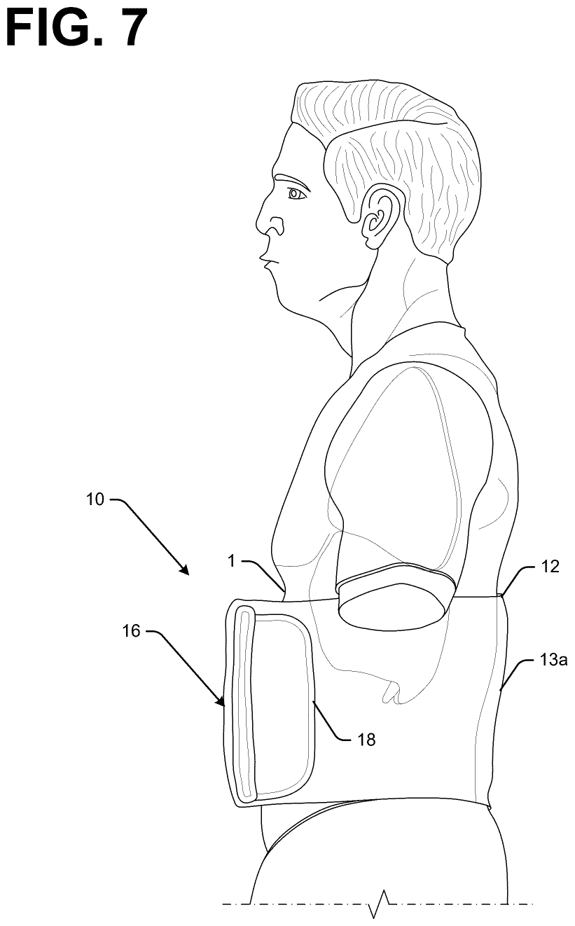

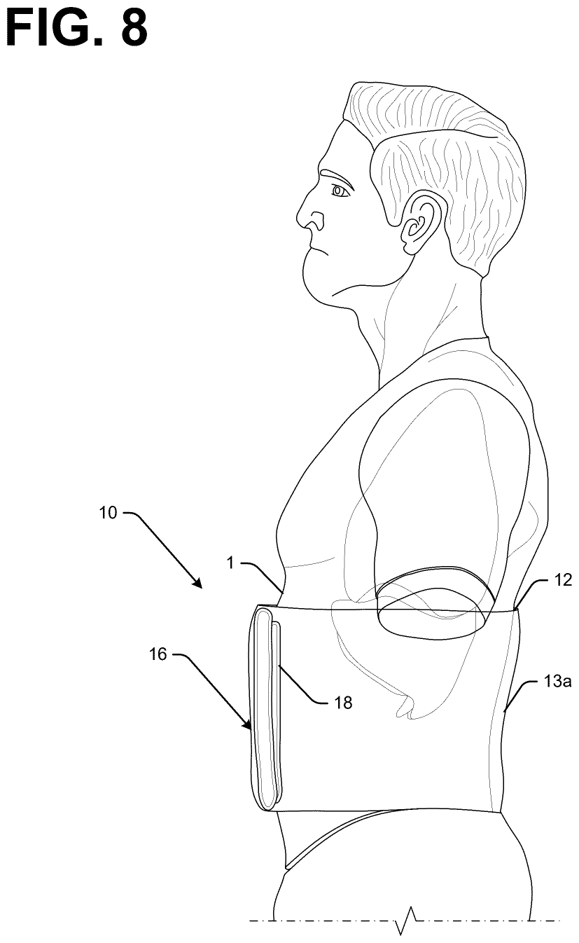

FIGS. 7-8 illustrate example operation of the example abdominal pressure exsufflation belt 10 for pulmonary restrictive or pulmonary obstructive breathing. When connected to a positive pressure ventilator, the bladder 14 is rhythmically inflated by a mandatory preset rate and tidal volume to assist the patient on exhalation and then deflated during the expiratory phase of the ventilator allowing for the patient to increase his or her inspiratory tidal volumes.

In use, the patient should be sitting in the upright position. Optimum or increased tidal exchange may be achieved by varying the angle at the hip from low Fowlers position @30 degrees to high Fowlers position or @75 degrees maximum above the horizontal position. The hook-and-loop fasteners 24 may be adjusted to secure the bladder 14 in the proper position adjacent to the abdomen 1.

The device works by applying intermittent positive pressure to the abdomen, which helps in passive inspiration. This method is particularly beneficial for patients with respiratory compromise, as it reduces the work of breathing and allows for deeper breaths. By eliminating the need for a face mask, the exsufflation belt allows patients to move more freely and engage in daily activities without the discomfort and restrictions associated with traditional ventilators. The device has been shown to enhance gas exchange, which is crucial for patients with conditions like pulmonary emphysema. This can lead to better oxygenation and overall respiratory function.

During operation, positive pressure from the ventilator inflates (FIG. 7) the bladder 14 that presses against the patient's abdomen 1 to move the diaphragm upward and compresses the abdomen causing the diaphragm to rise resulting in active exhalation. When the bladder is inflated, the patient's abdomen is compressed causing the diaphragm to rise which improves exhaled volumes. When the bladder deflates, the patient's diaphragm falls allowing for an increased inspiratory tidal volume. When the ventilator delivers a preset tidal volume to the bladder, the patient is exhaling and during the expiratory phase of the ventilator the patient is inhaling.

As the bladder deflates (FIG. 8), the patient's diaphragm falls, causing an increased inspiratory tidal volume. When the ventilator delivers a preset tidal volume to the bladder, the patient is exhaling. During the expiratory phase of the ventilator, the patient is inhaling, the reverse of standard positive pressure ventilation. In an example, the ventilator is set to administer up to 18 breaths per minute (BPM) and pressures up to 50 centimeters (cm) of water.

The abdominal pressure exsufflation belt 10 is a safe and easy to use respiratory aid. The abdominal pressure exsufflation belt 10 promotes deep breathing, improves tidal volume and allows rapid rehabilitation of many severely paralyzed patients. In an example, the components and connections depicted in the figures may be used to carry out the operations described herein.

The abdominal pressure exsufflation belt 10 provides anatomical support since the patient must be sitting in the upright position. Optimum or increased tidal exchange may be achieved by varying the angle at the hip from low Fowlers position @30 degrees to high Fowlers position or @75 degrees maximum above the horizontal position. The hook-and-loop fasteners 24 may need adjustment to secure the bladder 14 in the proper position

The abdominal belt 12 may be adjusted to achieve the best combination of patient comfort and ventilatory efficiency. If the abdominal belt 12 is too snug, the patient may be extremely uncomfortable and if it is too loosely positioned, it may not work effectively. Trial and error adjustments to the belt fit and volume/pressure delivered from the ventilator are necessary for achieving the best combination of belt comfort and efficiency. It is recommended that the abdominal belt 12 be fitted and worn as tightly as the patient can comfortably tolerate. If the abdominal belt 12 is worn too loosely, it could result in excessive wear and shortened service intervals for the ventilator.

A method of treating a breathing condition may include providing an abdominal pressure exsufflation belt for wearing about an abdomen of a person; connecting the abdominal pressure exsufflation belt to a ventilator device; and adding air from the ventilator device to a bladder positioned by the abdominal pressure exsufflation belt against the abdomen of the person to a pressure corresponding to an exhaled tidal volume of the person.

The method of treating a breathing condition may further include adjusting airflow from the ventilator device to increase the pressure based on the exhaled tidal volume of the person.

The method of treating a breathing condition may further include adjusting airflow from the ventilator device to lower the pressure based on the exhaled tidal volume of the person.

The method of treating a breathing condition may further include adjusting the pressure to lower end tidal CO₂ during breathing by the person.

The method of treating a breathing condition may further include confirming end tidal CO₂ and exhaled tidal volume during breathing by the person.

The method of treating a breathing condition may further include adjusting the pressure provided by the ventilator device based on at least one of ventilation device parameters, arterial oxygen saturation, and end tidal CO2.

The operations described herein are provided to illustrate example implementations. It is noted that the operations are not limited to the ordering shown. Still other operations may also be implemented.

During fitting, set up, and calibration of the abdominal pressure exsufflation belt 10, a therapist should:
(i) Explain the usage and rationale for the system to the patient and encourage the patient to ask questions about the system along with risks and benefits.
(ii) Ask the patient to empty his or her urinary bladder before starting the procedure.
(iii) Measure and document the patient's exhaled tidal volumes, forced vital capacity, end tidal CO2 and SaO2 on ambient room air or supplemental oxygen as needed.
(iv) Apply the Exsufflation Belt at the breath level of the patient's FRC (at the end of a forced exhalation) with a snug fitting.
(v) With patient sitting upright or in high Fowlers position as tolerated fill the bladder from the ventilator to the level of pressure and comfort tolerated by the patient for an exhaled tidal volume greater than the patient's own exhaled volumes prior to the application of the belt and a lower respiratory rate closer to normal if the patient was tachypneic prior to the application of the belt.
(vi) Check the patient's end tidal CO2 and exhaled tidal volume aiming for lowering the CO2 without too much change causing a marked alkalosis. If all is satisfactory the ventilatory settings may be prescribed for the upright sitting position.
(vii) Then, as postural changes may require adjustments to the ventilator, repeat the procedure with the patient in semi-recumbent position and measure changes in ventilatory parameters, SaO2 and end tidal CO2 so the patient might nap while the belt assists in the work of breathing. If all is satisfactory any new ventilator adjustments may be prescribed for the semi-recumbent position.
(viii) RESPIRATORY SATIETY is achieved when the patient has dyspnea relief, often evidenced when the patient smiles or falls asleep. Absence of dyspnea should be the goal as opposed to achieving a certain pressure.

The entire procedure should be documented in the patient's record. The therapist should teach the patient and family all of the above and ask them to keep a journal of usage recording hours of use per day, sleep if refreshed, and any changes in appetite or eating. Patients can eat with the belt working with instructions to swallow at the end of exhalation and before the next inspiration as we normally pause our breathing to swallow. The therapist should be mindful and ready to address any issues anytime as needed.

During the initial setup of the ventilator and abdominal pressure exsufflation belt 10, the patient should be encouraged to relax as much as possible and allow the belt to do most of the work of exhalation. Then the patient's exhaled volumes can be more accurately measured, recorded and compared for each of the various ventilator settings using a Wrights or other similar calibrated respirometer together with nose clips and mouth seal if necessary.

During this time it is equally important for the therapist to observe patient comfort levels as well as monitoring the exhaled volumes for each adjustment to the ventilator settings. The optimal ventilator settings are found when the patient is most comfortable and his or her exhaled volumes have improved sufficiently to allow a more normal breathing pattern. In most cases improved exhaled volumes result in a slower respiratory rate. A more effective exhalation allows more time for a deeper inspiration and a more comfortable and efficient breathing pattern.

For most patients the simplest and most efficient way to assist the patient's exhalation is for the ventilator to deliver a preset tidal volume to the bladder 14 using a constant flow square wave form. A constant flow square wave form refers to a consistent flow rate delivered by a mechanical ventilator during the inspiratory phase, resulting in a square-shaped waveform on the flow monitor. This means that the flow rapidly reaches a set level and remains constant throughout the breath until the exhalation phase begins to provide a steady stream of air. In an example, the appropriate tidal volume setting generates pressure in the bladder somewhere between 20 and 50 cm of water. The appropriate level of gas pressure in the bladder 14 can be determined by the level of improvement in the patient's exhaled tidal volumes as measured with a respirometer. The tidal volume fills the bladder 14 to the extent needed for creating a desired pressure on the patient's abdomen and causing the patient to exhale.

Adjustments to the ventilator peak flow or inspiratory time setting can increase or decrease the time allowed for the bladder 14 to inflate and for the patient to exhale. The therapist can then observe the patient's exhaled volumes and comfort level on various ventilator settings to determine what works best for each individual patient. The time period for bladder inflation matches the time required for the patient to exhale a normal breath.

Pressures between 20 cm of water and 50 cm of water at breathing rates of 8 to 16 breaths per minute are considered normal for applications. These operating parameters can vary depending on the size and tightness of the belt, the patient's size and chest elasticity, the angle of uprightness, and the degree of patient relaxation.

Trial and error adjustments in 5 cm of water pressure increments are recommended until the patient achieves an optimal combination of comfort and ventilatory efficiency.

In an example use case, patients with Chronic Obstructive Pulmonary Disease (COPD) often experience difficulty breathing due to obstructed airways. The abdominal pressure exsufflation belt 10 can assist in improving ventilation and reducing the effort required for each breath. This can help patients perform daily activities with greater ease and comfort.

In another example use case, patients may experience weakened respiratory muscles after certain types of surgery, and may need additional support to breathe effectively. The abdominal pressure exsufflation belt 10 can provide non-invasive ventilation support, aiding in the recovery process by ensuring adequate oxygenation and reducing the risk of complications such as pneumonia.

In another example use case, neuromuscular disorders conditions, such as muscular dystrophy or amyotrophic lateral sclerosis (ALS), can severely impact respiratory function. The abdominal pressure exsufflation belt 10 can assist individuals with these disorders by providing necessary respiratory support, helping them maintain better breathing function and overall quality of life.

In another example use case, patients with obstructive sleep apnea may find traditional CPAP masks uncomfortable. The abdominal pressure exsufflation belt 10 offers an alternative method of maintaining airway pressure. By using the In another example use case, patients can achieve effective ventilation without the discomfort of a facial mask, improving compliance with their treatment.

Home care for respiratory insufficiency is another example use case. Patients with respiratory insufficiency due to various medical conditions can benefit from the abdominal pressure exsufflation belt 10 as a home-based ventilation solution. The abdominal pressure exsufflation belt 10 allows the patient to receive the necessary respiratory support without the need for hospitalization or more invasive procedures, making it a practical option for long-term care.

In another example use case, in emergency scenarios where rapid respiratory support is needed, the abdominal pressure exsufflation belt 10 can be quickly deployed to provide immediate assistance. Its portability and ease of use make it suitable for use by first responders and in field settings where traditional ventilation methods may not be available.

The use cases described herein are provided to illustrate example implementations. It is noted that the use cases are not intended to be limiting. Still other use cases may also be implemented, as will be readily apparent to those having ordinary skill in the art after becoming familiar with the teachings herein.

It is noted that the examples shown and described are provided for purposes of illustration and are not intended to be limiting. Still other examples are also contemplated.

1. An abdominal pressure exsufflation belt, comprising:
an abdominal belt configured to be worn by a person about their abdomen;
a pouch of the abdominal belt;
a bladder in the pouch;
tubing connected between the bladder and an external ventilator to enable air flow from the external ventilator to expand the bladder and press against the abdomen of the person wearing the abdominal belt.

2. The abdominal pressure exsufflation belt of claim 1, wherein expansion of the bladder delivers a force to the abdomen resulting in expiration as the external ventilator inflates the bladder, followed in sequence by passive inspiration by the person wearing the abdominal belt as the bladder deflates.

3. The abdominal pressure exsufflation belt of claim 1, further comprising an opening formed in the pouch for providing the bladder in the pouch and for removing the bladder from the pouch.

4. The abdominal pressure exsufflation belt of claim 1, further comprising a rigid portion of the abdominal belt, the rigid portion configured to direct pressure from the bladder toward the abdomen of the person wearing the abdominal belt.

5. The abdominal pressure exsufflation belt of claim 4, further comprising a plurality of slots in the abdominal belt for receiving a rigid structure therein.

6. The abdominal pressure exsufflation belt of claim 5, wherein the rigid portion is formed by the rigid structure in the plurality of slots in the abdominal belt.

7. The abdominal pressure exsufflation belt of claim 6, wherein the rigid structure is at least one clothing stay.

8. The abdominal pressure exsufflation belt of claim 1, further comprising a closure mechanism to hold the abdominal belt about the abdomen of the person wearing the abdominal belt.

9. The abdominal pressure exsufflation belt of claim 8, wherein the closure mechanism is a hook-and-loop closure.

10. The abdominal pressure exsufflation belt of claim 1, wherein the bladder has a substantially oval shape.

11. The abdominal pressure exsufflation belt of claim 1, further comprising a manometer inline with the tubing to indicate pressure in the bladder.

12. An abdominal pressure exsufflation belt, comprising:
an abdominal belt configured to be worn by a person about their abdomen;
a pouch formed in the abdominal belt;
a bladder in the pouch;
a reinforcement provided in the abdominal belt to direct pressure from the bladder toward the abdomen of the person wearing the abdominal belt;
tubing connected between the bladder and an external ventilator, wherein the external ventilator fills the bladder to deliver a force to the abdomen resulting in expiration, followed in sequence by passive inspiration by the person wearing the abdominal belt as the bladder deflates.

13. A method of treating a breathing condition, comprising:
providing an abdominal pressure exsufflation belt for wearing about an abdomen of a person;
connecting the abdominal pressure exsufflation belt to a ventilator device; and
adding air from the ventilator device to a bladder positioned by the abdominal pressure exsufflation belt against the abdomen of the person to a pressure corresponding to an exhaled tidal volume of the person.

14. The method of claim 13, further comprising adjusting airflow from the ventilator device to increase the pressure based on the exhaled tidal volume of the person.

15. The method of claim 13, further comprising adjusting airflow from the ventilator device to lower the pressure based on the exhaled tidal volume of the person.

16. The method of claim 13, further comprising adjusting the pressure to lower end tidal CO2 during breathing by the person.

17. The method of claim 13, further comprising confirming end tidal CO₂ and exhaled tidal volume during breathing by the person.

18. The method of claim 13, further comprising adjusting the pressure provided by the ventilator device based on at least one of ventilation device parameters, arterial oxygen saturation, and end tidal CO2.
